(19) United States
(12) Patent Application Publication
(10) Pub. No.: US 2019/0092571 A1
(43) Pub. Date: Mar. 28, 2019

(54) Moving Assistance Device

(71) Applicant: Mark Rumboldt, Evanston, IL (US)

(72) Inventor: Mark Rumboldt, Evanston, IL (US)

(21) Appl. No.: 15/925,697

(22) Filed: Mar. 19, 2018

Related U.S. Application Data
(60) Provisional application No. 62/473,156, filed on Mar. 17, 2017.

(51) Int. Cl. B65G 7/12; A45F 3/14

(52) U.S. Cl. CPC B65G 7/12; A45F 3/14

(57) ABSTRACT

A Moving Assistance Device comprises a plurality of straps, comprising an inner strap and an outer strap; a plurality of adjustable and removable handles; and a plurality of buckles, wherein the buckles and handles travel along the straps providing means of tightening and securing the straps to an object to be moved.

### CLAIM OF PRIORITY

This patent application claims priority under 35 USC 119 (e) (1) from U.S. Provisional Patent Application Ser. No. 62/473,156 filed Mar. 17, 2017, of common inventorship herewith entitled, “FURNITURE ASSISTANCE MOVING DEVICE,” which is incorporated herein by reference as though the same were set forth in its entirety.

### FIELD OF THE INVENTION

The present invention pertains to the field of moving devices, and more specifically to the field of furniture assistance moving devices specially designed for making carrying heavy objects up stairways much easier.

### BACKGROUND OF THE INVENTION

Virtually every person moves not once but many times throughout his or her life; and whether or not they use a commercial moving service for these moves, somebody is going to be securing and moving their furniture and appliances. It would be desirable to make moving furniture and appliances, or any other bulky object lacking good handholds, an easier, quicker, and safer job.

The prior art has put forth several designs for a furniture moving assistance device. Among these are:

U.S. Pat. No. 6,193,293 to Danilo Ybanez provides an apparatus adapted for securing and carrying box-shaped cargo, that allows the ready transportation of boxes through airports, train stations, bus terminals, and all other like applications. The apparatus generally comprises a pair of retaining straps, a pair of horizontally disposed straps disposed to form adjustable loops, a pair of securing straps also disposed to form adjustable loops, and a pair of handles. The retaining straps surround and support the sides and bottom surfaces of the box. The horizontally disposed straps secure the front, rear, and side surfaces of the box. The securing straps secure the front, rear, bottom, and top surface of the box. A cross strap transverses the box between its side surfaces and is disposed perpendicularly to the securing straps. Once secure by the apparatus, a box may be easily toted around by use of the handles, thereby facilitating transport of such box-shaped cargo.

U.S. Pat. No. 4,431,226 to John K. Weilert provides improvements in large object handling devices, particularly mattress carriers; improved wrap-around band or strap mattress carriers to enable two people to carry large and cumbersome mattresses; variably adjustable wrap-around band and strap mattress carrying and handling devices which are adjustable and useable to fit and carry more than one size of mattress.

U.S. Pat. No. 7,926,860 to Brad Hill et al provides a manual lifting apparatus for providing adjustable handles that allow a person to more effectively, efficiently, and safely lift objects. The present invention provides a webbing attached to two ergonomic handles that assists a user in lifting objects. The handles are adjustable to allow a user to adjust the height from which the user must lift the object thus allowing the user to effectively lift an object from the power zone to more effectively and safely lift objects.

None of these prior art references describe the present invention.

### SUMMARY OF THE INVENTION

It is an object of the present invention to provide a moving assistance device, especially useful for moving furniture specially designed for making carrying heavy objects up stairways much easier.

### BRIEF DESCRIPTION OF THE DRAWINGS

FIG. 1 is a perspective view illustrating a moving assistance device, constructed in accordance with the present invention, showing parallel handles.

FIG. 2 is front perspective view illustrating the moving assistance device, constructed in accordance with the present invention, showing handles at two different levels.

### DETAILED DESCRIPTION OF THE INVENTION

Please refer to the drawings.

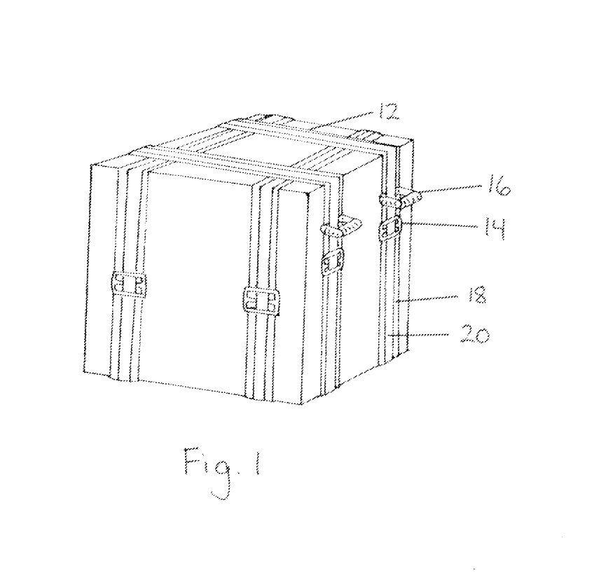

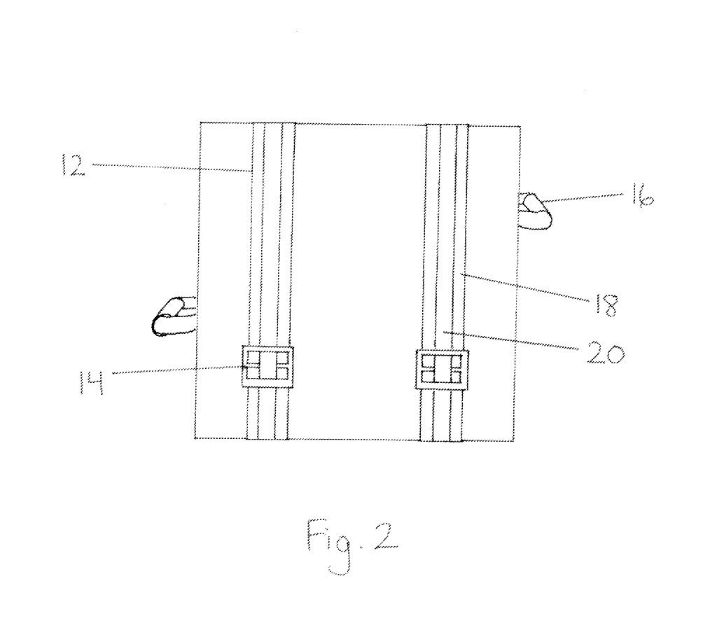

As illustrated in FIGS. 1 and 2, the present invention, Moving Assistance Device, also referred to as Adjustable Moving Straps with Removable Handles, comprises a convenient device for moving a variety of objects while providing custom handholds for ease of operation and reliable load bearing, combined with non-marring contact with the object, and maximizing safety.

In a primary embodiment, shown in FIG. 1, Adjustable Moving Straps with Removable Handles consists of straps 12, constructed of any suitable material, such as woven nylon. Straps 12 are further comprised of outer strap 18 and inner strap 20, constructed of woven nylon. Adjustable Moving Straps with Removable Handles further consists of removable handles 16, constructed of any suitable material such as molded plastic or metal, more specifically steel. Adjustable Moving Straps with Removable Handles further consists of buckle 14, of any suitable type known in the art such as slide buckle, double ring buckle, flip closure buckle, ratchet buckle, or webbing buckle, constructed of any suitable material such as metal, more specifically steel.

In the primary embodiment, outer strap 18 is 3 inches in width and 10 feet in length. Inner strap 20 is 2 inches in width and 10 feet in length. Removable handle 16 is positionable anywhere along the length of straps 12 to provide a handhold. Buckle 14 is positionable anywhere along the length of straps to secure the straps in a fixed position.

Straps 12 are positioned around the object to be moved in the desired configuration. Straps 12 are positioned such that outer strap 18 is flush against the surfaces of the object, and inner strap 20 is flush against strap 18 and centered along it lengthwise. Handle 16 is positioned between outer strap 18 and inner strap 20 wherever the user wishes to create a handhold. Both outer strap 18 and inner strap 20 are fed through buckle 14. Pulling outer strap 18 and inner strap 20 taught through buckle 14 secures the object in a fixed position relative to straps 12. Moreover, when outer strap 18 and inner strap 20 are pulled taught through buckle 14, the positions of outer strap 20 and inner strap 18 are fixed relative to one another. Further, when outer strap 18 and inner strap 20 are pulled taught through buckle 14, removable handle 16 is fixed in the desired position to form a handhold protruding from the object to be moved.

As shown in FIG. 2, removable handle 16 may be placed anywhere along the length of straps 12 to suit the needs of the parties carrying the objects to be moved. Any number of straps 12, buckle 14, and removable handhold 16 may be combined to suit the needs of the consumer.

In an embodiment, the buckle can comprise a shape and clip to provide for attaching one strap to another to increase the effective length of the strap.

Adjustable Moving Straps with Removable Handles offers consumers an ideal way to move objects of any size and shape with fitted straps and custom-configured handholds, optimized for ease of handling and reliable load bearing. The unique adjustable straps and enhance safety and minimize the risk of falls, personal injury, and destruction of property, while securing loads with non-marring points of contact.

In an embodiment, the present invention is a Moving Assistance Device comprises one or more adjustable straps, and equipped with both an adjustable buckling mechanism and a pair of handles that may be placed at any point along the strap for a pair of convenient, secure handholds. The Moving Assistance Device can be packaged as a single strap with two handles; or as a set of two or more straps with two handles per strap. The buckle mechanism permits multiple straps to be linked together to form a long single strap.

The Moving Assistance Device system permits two workers to prepare, lift, and move a wide variety of difficult, cumbersome objects, from dressers and bureaus to mattresses, box-springs, and appliances such as refrigerators and stoves. To prepare such objects, the workers first wrap them securely with the Moving Assistance Device, using the removable handles to create two or more handholds on either side of the object, then securing the straps via the buckles. Once the straps are buckled, the object may be lifted and carried by the handles.

With the Moving Assistance Device, both the buckle mechanism and the removable handles are designed for ease of operation, reliability under load, and non-marring contact with the object being carried.

The great advantage of the Moving Assistance Device is that this simple system makes the moving of large, bulky objects, from bedroom dressers to refrigerators and ranges, manageable and convenient. The difficulty posed by such objects is not their weight but their lack of decent handholds; and without a good grip, even the strongest movers will have a tough time. Anyone who's moved furniture can tell you that it isn't just a matter of how strong you are, because unless you can get a good purchase on something, a good grip and hold on it, you just can't lift and carry it. The Moving Assistance Device has been designed to secure the object with a non-marring, buckling strap that can be configured as needed; and to provide multiple handholds, handles that can be positioned anywhere along the straps, to offer superior grips, so that a pair of movers can easily handle the object. Adaptable enough to manage both furniture and appliances; fabricated in tough, long-lasting, non-marring nylon webbing; and requiring nothing in the way of maintenance beyond a wipe-down after use, the Moving Assistance Device provides a lifetime's working service, and to do so at an eminently affordable price. For movers and commercial moving companies, as well as for the millions of users who “move-it-yourself,” the Moving Assistance Device will have a strong appeal, and this moving accessory should find a wide and enthusiastic reception in the commercial-moving and consumer markets.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A moving assistance device comprising: a plurality of straps, a plurality of handles, and a plurality of buckles, wherein a strap comprises an outer strap and an inner strap; a handle is adjustable along the strap, and the handle is removable; a buckle is capable of securing the outer strap and the inner strap together.

2. The moving assistance device of claim 1, wherein the strap comprises woven nylon.

3. The moving assistance device of claim 1, wherein the handle is constructed of molded plastic or metal.

4. The moving assistance device of claim 1, wherein the buckle is selected from the group consisting of: slide buckle, double ring buckle, flip closure buckle, ratchet buckle, and webbing buckle.

5. The moving assistance device of claim 4, wherein the buckle is constructed of steel.

6. The moving assistance device of claim 1, wherein the handle is positionable anywhere along the length of the strap to provide a handhold.

7. The moving assistance device of claim 1, wherein the buckle is positionable anywhere along the length of the strap to secure the strap and buckle in a fixed position.

8. A method of moving an object comprising using a moving assistance device comprising: a plurality of straps, a plurality of handles, and a plurality of buckles, wherein a strap comprises an outer strap and an inner strap; a handle is adjustable along the strap, and the handle is removable; a buckle is capable of securing the outer strap and the inner strap together, the method comprising:
a) positioning one or more straps around the object to be moved in the desired configuration, wherein the one or more strap is positioned such that outer strap is flush against the surface of the object, and inner strap is flush against strap outer and centered along the object lengthwise;
b) positioning handle between outer strap and inner strap wherever the user wishes to create a handhold;
c) feeding outer strap and inner strap through the buckle;
d) pulling outer strap and inner strap taught through buckle to secures the object in a fixed position;
e) moving the object by use of the handle.
Moreover, when outer strap 18 and inner strap 20 are pulled taught through buckle 14, the positions of outer strap 20 and inner strap 18 are fixed relative to one another. Further, when outer strap 18 and inner strap 20 are pulled taught through buckle 14, removable handle 16 is fixed in the desired position to form a handhold protruding from the object to be moved.
